(19) United States
(12) Patent Application Publication
(10) Pub. No.: US 2013/0024203 A1
(43) Pub. Date: Jan. 24, 2013

(54) PROVIDING DYNAMIC RECOMMENDATIONS FOR POINTS OF INTEREST UTILIZING AUTOMATICALLY OBTAINED COLLECTIVE TELEMETRY TO ENHANCE USER EXPERIENCE

(71) Applicants: ROMELIA H. FLORES, KELLER, TX (US); TASSANEE K. SUPAKKUL, EULESS, TX (US); MATHEWS THOMAS, FLOWER MOUND, TX (US); JULIO WONG, PEMBROKE PINES, FL (US)

(72) Inventors: ROMELIA H. FLORES, KELLER, TX (US); TASSANEE K. SUPAKKUL, EULESS, TX (US); MATHEWS THOMAS, FLOWER MOUND, TX (US); JULIO WONG, PEMBROKE PINES, FL (US)

(73) Assignee: NTERNATIONAL BUSINESS MACHINES CORPORATION, ARMONK, NY (US)

(21) Appl. No.: 13/186,733

(22) Filed: Jul. 20, 2011

(51) Int. Cl. G06Q 10/00

(52) U.S. Cl. 705/1.1

(57) ABSTRACT

A schedule and recommendations associated with one or more points of interest can be identified. The points of interest can be associated with a geographical region. Telemetry associated with a one or more computing devices can be received. The computing devices (e.g., mobile phone with sensors) can be associated with one or more points of interest. Telemetry data can be evaluated against a recommendation criteria and the user preference. A schedule and recommendations can be determined based on the evaluating telemetry information, historic data, criteria and preferences. The schedule and recommendation(s) enhance visits to points of interest.

### BACKGROUND

The present invention relates to the field of scheduling and, more particularly, to providing dynamic recommendations for points of interest utilizing automatically obtained collective telemetry to enhance user experience.

Family outings can be a source of much enjoyment for families. Many family outings often include theme parks which are frequently large and can include many attractions. Such outings can usually be a source of stress and concern for family members. It is easy for family members to become distracted by the excitement and attractions. Frequently, attempts to plan the outing results in failure due to long wait times at attractions, different family preferences, and complex theme park layouts. For example, people can often become upset because they were not able to visit a favorite attraction due to limited time for the outing.

To alleviate this problem, many theme parks offer mobile phone applications which can help families plan their experience/day at the theme park. These applications frequently include directions between attractions, a schedule of attractions, and even promotions. These applications however, are static and do not adapt to changing situations within the theme park. For example, theme park foot traffic, weather conditions, and special events are dynamic conditions which these applications do not provide. For example, some attractions can quickly become crowded and wait times can increase quickly. Further, many theme parks are open air parks which have many outdoor attractions and/or venues. These attractions can become inaccessible due to bad weather conditions (e.g., thunderstorms) and/or technical failures.

Currently, decisions about visiting an attraction require many manual steps. Steps can include, checking the weather, calling a friend at an attraction to find out wait times, and finding nearby restaurants of preference. These applications fall short in many areas including providing real-time information for theme park attendees. Further, many of these applications are limited to a theme park which results in multiple applications being required; one application for each theme park. Since these applications require payment to acquire, the costs to enjoy theme park attractions increase quickly.

### BRIEF SUMMARY

One aspect of the present invention can include a system, an apparatus, a computer program product, and a method for providing dynamic schedules and recommendations for points of interest utilizing automatically obtained collective telemetry to enhance user experience. A schedule and recommendations associated with one or more points of interest can be identified. The points of interest can be associated with a geographical region. Telemetry associated with one or more computing devices can be received. The computing devices (e.g., mobile phone with sensors) can be associated with one or more points of interest. Telemetry data can be evaluated against a recommendation criteria and the user preference. A schedule and recommendation can be determined based on the evaluation of telemetry information, historic data and preferences. The schedule and recommendations enhance user visits to various points of interest.

Another aspect of the present invention can include an apparatus, a computer program product, a method, and a system for providing a dynamic schedule and recommendations for points of interest utilizing automatically obtained collective telemetry to enhance user experience. A recommendation engine can be configured to generate a recommendation associated with telemetry received from one or more computing devices linked to one or more points of interest. The recommendation can be generated utilizing a historic data, a recommendation criterion, and a preference. The recommendation can be associated with points of interest. The point of interest can be associated with a geographical region. A data store can be used to store the recommendation and the recommendation criteria. The recommendation criteria can be a threshold value. The threshold value can be evaluated against the telemetry to determine the state of one or more points of interest.

### BRIEF DESCRIPTION OF THE SEVERAL VIEWS OF THE DRAWINGS

FIG. 1 is a schematic diagram illustrating a scenario for providing dynamic recommendations for points of interest utilizing automatically obtained collective telemetry to enhance user experience in accordance with an embodiment of the inventive arrangements disclosed herein.

FIG. 2 is a schematic diagram illustrating a system for providing dynamic recommendations for points of interest utilizing automatically obtained collective telemetry to enhance user experience in accordance with an embodiment of the inventive arrangements disclosed herein.

FIG. 3 is a schematic diagram illustrating a method for providing dynamic recommendations for points of interest utilizing automatically obtained collective telemetry to enhance user experience in accordance with an embodiment of the inventive arrangements disclosed herein.

### DETAILED DESCRIPTION

The present disclosure is a solution for providing dynamic recommendations utilizing automatically obtained collective telemetry to enhance user experience. In the solution, telemetry data can be automatically collected from one or more computing devices. The computing devices can be associated with one or more points of interest within a geographical region. Telemetry can be analyzed to determine the state of a point of interest which can be utilized to generate a schedule and recommendations. The schedule and recommendations can be used to indicate the points of interest leading to a favorable visit. In one embodiment, a schedule can be generated based on user preferences and telemetry data. In the embodiment, the schedule can be dynamically updated based on telemetry data evaluation. That is, telemetry data can provide real-time information which can be utilized to create an optimum experience.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

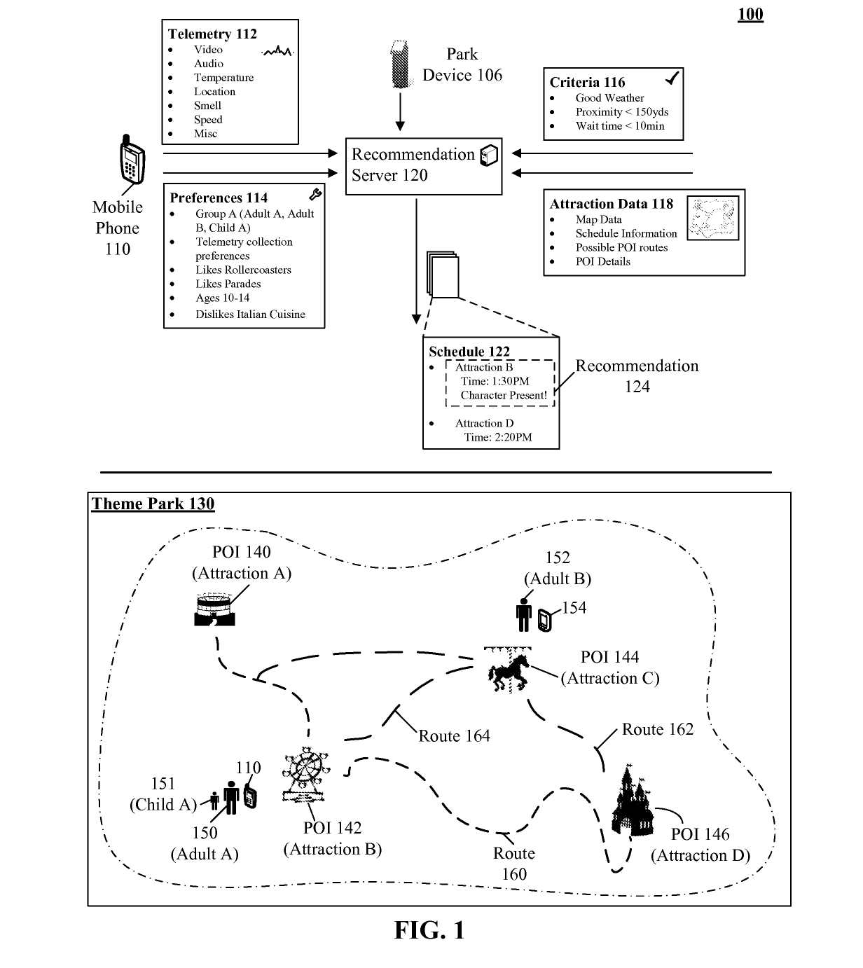

FIG. 1 is a schematic diagram illustrating a scenario 100 for providing dynamic recommendations for points of interest utilizing automatically obtained collective telemetry to enhance user experience in accordance with an embodiment of the inventive arrangements disclosed herein. In scenario 100, a recommendation server 120 can receive information 112-118 which can be utilized to generate a recommendation 124 for a schedule 122. It should be understood that information 112-118 can be collected and/or communicated in real-time or near real-time. For example, server 120 can provide real-time attraction recommendations for a patron within a theme park 130. It should be appreciated that the disclosure can leverage the ubiquitous nature of portable computing devices to provide copious volumes of telemetry which can be utilized to enhance a user experience by offering intelligent recommendations for activities and/or points of interest (POI).

As used herein, telemetry 112 can be data obtained from multiple sources (e.g., collective telemetry) associated with points of interest (e.g., POI 140-146) which can assist in recommendation 124 creation. In one instance, telemetry 112 can be obtained from mobile devices associated with visitor 152 to determine current weather conditions at point of interest 144 (e.g., Attraction C). In the instance, weather conditions can be evaluated to determine point of interest 144 can be visited during favorable weather conditions. For example, if weather conditions at POI 144 indicate heavy rain, server 120 can provide a recommendation to visit POI 146.

It should be appreciated that scenario 100 can be extended to different real-world scenarios including gathering events, exhibit hall events, fun fairs, carnivals, gardens, and the like. Telemetry 112 provided by computing devices at various points of interest can drive recommendation decisions. That is, the disclosure can permit assistance to attraction visitors (e.g., tourists) by enabling point of interest telemetry 112 to guide visitors to attractions quickly and easily. In one embodiment, the disclosure can generate a schedule 122 which can include point of interest recommendations for user specified duration. For example, a visitor can select point of interest recommendations for a city during rush hour which avoids city traffic.

It should be understood that the disclosure can be arbitrarily complex allowing multiple levels of granularity for recommendations to be delivered. In one instance, server 120 can provide a “best fit” follow up recommendation (e.g., next activity/point of interest) based on information 112-118. In another instance, server 120 can generate multiple recommendations allowing visitors to select the most preferred option and optimal route.

Telemetry 112 can be collected automatically from mobile phone 110 which can be communicated to server 120. Telemetry 112 can include, but is not limited to, an audio stream, a video stream, a temperature metric, a humidity metric, a pressure metric, an odor metric, a speed metric, a location, miscellaneous data, and the like. In one embodiment, miscellaneous data can include placeholders for future expansion or for data expected to be available or that is only available in some areas. In another embodiment, placeholders within the data 112 can exist for optional data (i.e., data that may include some additional costs or may represent a “premium” type of data). Telemetry 112 can be obtained from points of interest based on telemetry source density. For instance, when a crowd of visitors are nearby an attraction, one or more visitor mobile phones can be randomly selected and utilized to convey telemetry 112. That is, the number of telemetry sources can be arbitrarily defined enabling a scalable framework for obtaining telemetry. For example, video telemetry can be collected from a device 110, while temperature telemetry can be obtained from device 154 simultaneously. In one embodiment, telemetry 112 can be analyzed to establish visitor activity. For instance, an accelerometer within mobile phone 110 can be utilized to gather metrics which can be used to determine when a visitor is on an amusement ride. In this way, current user activity can be utilized as feedback to generate highly relevant recommendations for visitors. The invention can also utilize a number of dedicated devices, referred to as park devices 106 to collect telemetry data 112. In one embodiment, park devices 106 can include user-interactive stations, such as kiosks, which may perform additional functions (e.g., an ATM functionality, an automated information guide, etc.)

Preferences 114 are user established preferences associated with points of interest which aid in recommendation 124 creation. Preferences 114 can include, but is not limited to, grouping information (e.g., group size, group composition), telemetry collection preferences, attraction preferences, visitor details (e.g., age, medical conditions), cuisine preferences, wait time preferences, and the like. Preferences 114 can be associated with one point of interest (a preference for each point of interest), multiple points of interests (e.g., preferences for any theme park), and the like. Preferences 114 can be automatically determined based on information within phone 110, application data associated with phone 110, and the like. In one embodiment, preferences 114 can be persisted between theme park exhibits reducing visitor configuration actions. In one instance, preferences can include, group preferences, individual preferences, and the like. In one instance, traditional and/or proprietary conflict resolution actions can be utilized to create relevant recommendations for a group or visitor when group and individual preferences conflict. Preferences 114 can include heuristically determined options based on historic configurations, group member preferences (e.g., individual preferences), and the like.

Criteria 116 can be values which can be used to establish recommendation 124 candidacy. Criteria 116 can be relative and/or absolute criterion which can determine a recommendation validity. In one instance, criteria 116 can be minimum/maximum threshold values which can be programmatically evaluated against preferences 114. For example, temperature criteria 116 can be a numerical value of eighty degrees Fahrenheit. In another instance, criteria 116 can be associated with fuzzy logic enabling ranges of values to be evaluated similarly. For instance, weather criteria 116 can be a value of “cloudy”. Criteria 116 can include, but is not limited to, weather conditions, proximity values (e.g., distances from an attraction, group member distances), wait time options, transportation criteria, and the like. Criteria 116 can be automatically and/or manually established. In one instance, criteria 116 can be automatically established utilizing preferences 114 data.

Attraction data 118 can be information associated with points of interest (e.g., POI 140-146) which can permit server 120 obtain telemetry 112 from points of interest (e.g., Attractions A-D), generate recommendation 124 timetables, and the like. Attraction data 118 can include, but is not limited to, mapping data (e.g., theme park 130 map), scheduling information, special event occurrences, promotional events, guest services, facilities, transportation information, possible POI routes, POI details, and the like. Attraction data 118 can be provided by theme park 130 entities (e.g., theme park server), user submitted data (e.g., wait time, character appearances), and the like. The user submitted data for attractions can represent data about an attraction that a user submits, which is not provided by other sources. If attraction data 118 does not exist for a point of interest, additional data sources can be utilized.

Information 112-118 can be obtained from multiple sources such as third party servers, user owned devices, data repositories, and the like. Information 112-118 can conform to traditional data formats enabling rapid acquisition and usage of information. In instances where information 112-118 conforms to proprietary formats, conversion procedures can be performed to enable consumption of data. It should be appreciated that one or more portions of information 112-118 can be optional provided server 120 functionality is retained.

Schedule 122 can be a series of events spanning a time frame associated with one or more points of interest (e.g., theme park family itinerary). Initially, schedule 122 can be automatically and/or manually generated. Schedule 122 can include one or more recommendations 124. Recommendation 124 can include, but is not limited to, a point of interest, a date, a time, a group, reservation information, point of interest event information, and the like. In one instance, server 120 can generate recommendations which in turn can be leveraged by the user to modify schedule 122 for a group visiting a theme park 130 based on changing conditions within the theme park. In the instance, schedule 122 can be continually updated as the group travels the park 130. For instance, recommendation 124 can change from Attraction B to Attraction A when telemetry 122 indicates Attraction B is crowded.

Based on criteria 116 and attraction data 118, intelligent recommendations can be presented. For example, when a visitor visits an amusement ride, recommendations for similar rides which are nearby can be presented. Further, telemetry 112 can be conveyed to server 120 which can be analyzed to create navigation routes for visitors based on foot traffic between attractions. For example, a route 160, 162 from Attraction B to Attraction D to Attraction C can be quicker than route 164 from Attraction B to Attraction C.

The disclosure can simply group planning activities and coordination utilizing a “linked network” approach. In one embodiment, a creation of a “linked network” (e.g., Group A) which can periodically update members of the network of important occurrences. In the embodiment, special users such as theme park 130 characters (e.g., costumed characters) can be monitored to convey notifications when the characters are near members of the network. For example, Group A (e.g., Adult A, Adult B) members can receive a recommendation for Attraction B when a theme park character is nearby. In another embodiment, the “linked network” can allow groups of visitors to experience attractions in unison. In the embodiment, locations of each member of the group can be tracked which can provide relevant recommendations for each visitor and/or the group. For example, visitor 152 (e.g., Adult B) can obtain notifications when visitors 150, 151 arrive at point of interest 146 (e.g., Attraction D) to which the visitor 152 is traveling.

In another embodiment, a “linked network” can assist in locating lost visitors. In the embodiment, location information (e.g., Global Positioning System data) can be obtained for a visitor based on one or more visitor details. For example, a visitor can wear a wristband registered with the visitor name which can be utilized to locate the visitor. In yet another embodiment, images obtained from mobile phone 110 camera can be utilized in conjunction with location data which can assist in locating visitors.

In one configuration, the disclosure can be associated with a mobile phone application which can permit high level planning capabilities. For instance, appropriate attractions can be found by allowing a family to specify the number of visitors, ages, and visitors' favorite theme park character.

In another configuration, the disclosure can provide recommendations for multiple theme parks. In the configuration, telemetry can be collected from points of interest (e.g., attractions) from multiple theme parks to enable real-time recommendations to be provided. For example, when a rollercoaster theme park is crowded and attraction wait times are high, the disclosure can recommend a nearby water park.

Drawings presented herein are for illustrative purposes only and should not be construed to limit the invention in any regard. It should be appreciated that mobile phone 110 is an exemplary device and can include any computing device able to collect and/or communicate telemetry. It should be understood that the disclosure can tie into common user feed services including, but not limited to FACEBOOK, TWITTER, and the like. In one instance, feed service data can be utilized to obtain visitor position, visitor activity, proximate group members, and the like. It should be appreciated that the disclosure can be integrated with existing telemetry providing systems. For example, additional telemetry can be obtained from on-premise equipment (e.g., security cameras, motion detectors) to assist in recommendation determination.

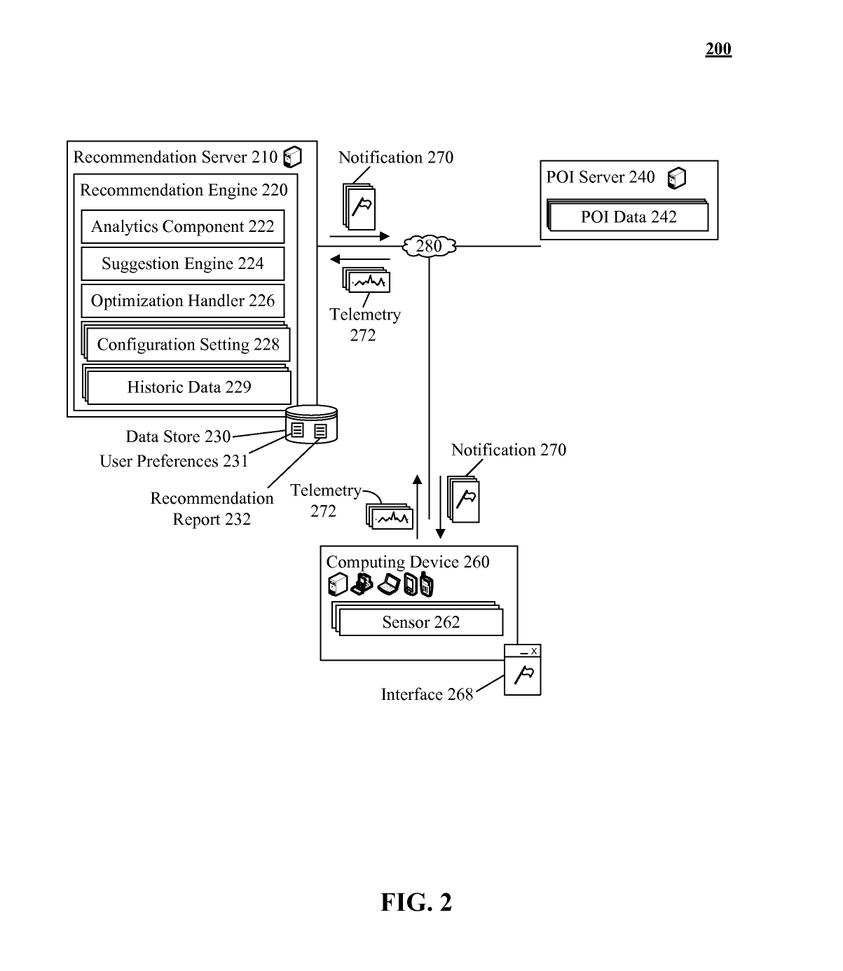

FIG. 2 is a schematic diagram illustrating a system 200 for providing dynamic recommendations for points of interest utilizing automatically obtained collective telemetry to enhance user experience in accordance with an embodiment of the inventive arrangements disclosed herein. In system 200, a recommendation engine within a recommendation server can provide a recommendation (e.g., notification 270) for a point of interest based on telemetry 272. System 200 components can be communicatively linked via network 280. In one instance, system 200 can be a component of a Service Oriented Architecture. In another instance, system 200 can be a functionality of an Application Programming Interface. It should be appreciated that system 200 can operate in real-time and/or near real-time permitting the system to react to the dynamic state of telemetry data, criteria and recommendations.

In one embodiment, server 210 can be a set of one or more servers, which perform functions (e.g, backend functions) for system 200 as detailed herein. In one embodiment, server 210 can transparently provide requisite functionality for performing disclosed capabilities. In one instance, system 200 can be associated with a pay-per-use service. In the instance, recommendations can be provided based on a one-time fee, a per visit fee, a per recommendation fee, and the like.

Recommendation server 210 can be a hardware/software entity able to receive data 242, 272 and/or convey notification 270. Server 210 functionality can include, but is not limited to, encryption/decryption, filtering, data collection, and the like. In one instance, server 210 can be a networked element within a networked computing environment. In another instance, server 210 can be a distributed system within a distributed computing network. In one instance, recommendation server 210 functionality can be available as a Software as a Service (SaaS).

Recommendation engine 220 can be a hardware/software element capable of generating a recommendation for a schedule based on telemetry. Engine 220 can include, but is not limited to, analytics component 222, suggestion engine 224, optimization handler 226, configuration setting 228, and historic data component 229. It should be understood that engine 220 can include additional components or lack described components provided that engine functionality is retained. In one embodiment, engine 220 functionality can be presented through a Web-enabled service.

Analytics component 222 can be a hardware/software element for examining telemetry 272, POI data 242, and configuration setting data 228. Component 222 functionality can include, but is not limited to, video analysis, audio analysis, environmental analysis, forecast analysis, and the like. For instance, if video recording of a crowd is received, component 222 can utilize facial recognition to determine a user is present at the video recording location. In one embodiment, video analysis can be employed to determine the current state of a point of interest. For example, voice analysis can be performed on a recording to estimate the number of people proximate to the recorder based on nearby conversations. Component 222 can be extensible permitting analysis of any metric associated with telemetry 272. For example, moisture data within telemetry 272 can be processed to provide information about current weather conditions.

Suggestion engine 224 can be a hardware/software entity for providing recommendations associated with one or more points of interest for a schedule. Suggestion engine 224 functionality can include, but is not limited to, dynamic schedule including recommendation generation, report 232 creation, forecasting, and the like. Engine 224 can utilize data 242, 272, 228, and optimization handler 226 output to create a recommendation. Engine 224 can create one or more recommendation options which can be associated with a score. The score can be computed using multiple factors including, but not limited to, best fit (e.g., based on preferences, recommendation criteria), closest (e.g., based on proximity), and the like. In one embodiment, engine 224 can be utilized to forecast scenario outcomes based on telemetry. In the embodiment, engine 224 can attempt to predict favorable and unfavorable outcomes based on telemetry 272 and/or historic data. For instance, engine 224 can collect temperature, crowd density, and crowd flow data to determine if an amusement ride is likely to be overrun with visitors within the next thirty minutes. In one instance, engine 224 can create a recommendation report 232 which can provide multiple recommendations.

Optimization handler 226 can be a hardware/software component able to improve recommendations based on internal and/or external feedback. Handler 226 functionality can include, score computation, report 232 optimization, and the like. Handler 226 can continually improve recommendations based on historic data. For instance, handler 226 can utilize historic data as feedback to determine which recommendations users select. In one embodiment, handler 226 can be utilized to improve telemetry selection and/or collection. In the embodiment, handler 226 can be capable of determining appropriate additional telemetry to improve recommendations. In one instance, handler 226 can be employed to improve suggestion 224 forecasting. The handler 226 can continually monitor and/or process feedback (e.g., user input, historic data, external data sources) to enhance outcome prediction.

Configuration setting 228 can be one or more options for establishing the behavior of system 200. Setting 228 can include, but is not limited to, component 222 settings, engine 224 options, handler 226 parameters, report 232 settings, notification 270 parameters, user preferences, and the like. Setting 228 can be used to tune forecasting, optimization, and the like.

Historic data component 229 can be a component used to gather, maintain, update, and leverage historical data component 229. Component 229 can be used in conjunction with other components, such as suggestion engine 224. Historic data component 229 can also be part of a feedback cycle, which is used to continuously improve the performance and system 200, ensure that the suggestions are consistent with observable phenomenon and/or group, person, and general interests. Historic data component 229 can maintain data sets of a previously collected information (e.g., telemetry 272, user recommendation selection), which may be maintained in data store 230. The component 229 can also update, sanitize (make anonymous to protect user identity), summarize, and otherwise manipulate historic data. Historic data can include historic group data including preferences, messages, notifications, and the like. Historic data can also include third party data, system 200 collected data, and the like.

Data store 230 can be a hardware/software component able to store data, such as user preferences 231, recommendation reports 232, historical telemetry data, and the like. Data store 230 can be a Storage Area Network (SAN), Network Attached Storage (NAS), and the like. Data store 230 can conform to a relational database management system (RDBMS), object oriented database management system (OODBMS), and the like. Data store 230 can be communicatively linked to server 210 in one or more traditional and/or proprietary mechanisms.

Recommendation report 232 can be a schedule containing one or more recommendations associated with a point of interest and/or a user recommendation request. Report 232 can be associated with a unique identifier permitting multiple reports 232 to be linked with different users, groups, and the like. Report 232 can be persisted to enable rapid responses to common user requests. Report 232 can be persistently updated to reflect point of interest state, user preferences, and/or recommendation criteria.

POI (point of interest) server 240 can be a hardware/software element for communicating POI data 242 and/or historic data. Server 240 can include, but is not limited to, POI data 242, historic data, additional data services, and the like. It should be appreciated that POI server 240 can be an optional component. Server 240 can be a third-party component which can cooperatively communicate with server 210 and/or computing device 260. For instance, device 260 can communicate telemetry 272 with a theme park server (e.g., server 240) which can aggregate the data (e.g., historic data) and convey the data to be analyzed by server 210.

POI data 242 can be a data set (e.g., attraction data 118) associated with a point of interest. The data set can include environmental data (e.g., physical characteristics, geographical features), historic data, real-time information, and the like. POI data 242 can include traffic flow information (e.g., foot traffic), delays (e.g., wait times), and the like.

Interface 268 can be a user interactive component permitting interaction with a schedule, recommendations, notifications 270, and/or a recommendation report 232. Interface 268 can be communicatively linked to computing device 260. Interface 268 can be a graphical user interface (GUI), voice user interface (VUI), mixed-mode interface, touch sensitive interface, and the like. Interface 268 can permit configuration of sensor 262, preferences, recommendation report 232, and the like. In one instance, sensors can be selectively enabled based on user requirements and/or device 260 constraints. For example, when device 260 battery is low, high consumption sensors (e.g., video camera) can be optionally turned off while other low consumption sensors can continue to operate. In another interface, user preferences can establish an auto intake mode for the device 260. This means that the device can “automatically” take pictures and video (or capture data using other available sensors 262) based on visibility, recommendation from a central server (e.g., recommendation server 210) and other factors. For example server 210 can detect unusual traffic for a POI at a particular time and may require additional information, which causes it to request sensor equipped devices 260 proximate to the POI to provide additional telemetry data 272. In one embodiment, one or more of the devices 260 can be equipped with special lenses or functionality, which enable a close to 360 degree horizontal and/or vertical video to be captured. Many devices with both front and rear facing camera are capable of this type of functionality. Further, devices with 3-D video are emerging, which can be particularly well suited for a significant arch of video capture (even if not a complete 360 degree capture). It should be appreciated that capturing vertical telemetry data can be particularly useful for either conditions and/or for observing a path that a given user is on (assuming the device 260 is a mobile device carried by a user). In one embodiment, devices 260 can provide capability information to server 210, which assists the server 210 when it utilizes internal functionality for requesting additional information from devices 260.

In one instance, interface 268 can present a contact list including members and/or non-members of a group associated with the visitor. In the instance, group members can convey messages to group members, track other visitors, track special users (e.g., theme park characters), and the like. Overall, many examples are presented herein to emphasize the flexibility of system 200 and the advantages achieved in context of POIs through leveraging a myriad of sensors 262, many of which are portable/mobile and specific to one or more customers frequenting the POIs.

Telemetry 272 can be associated with one or more sensors 262 of device 260. Telemetry 272 can be associated with one or more security mechanisms including, data protection, encryption, and the like. Telemetry 272 can be conveyed in real-time and/or near real-time. In instances where telemetry 272 cannot be conveyed immediately (e.g., communication outage), the telemetry 272 can be stored and communicated when possible.

Notification 270 can be a message associated with one or more recommendation (e.g., recommendations). Notification 270 can include, but is not limited to, special user alerts, group alerts, recommendations, and the like. In one instance, notification 270 can alert a user that a group member is not proximate. In the instance, location information of the group member can be presented permitting rapid locating of group member. For example, notification 270 can notify parents when their offspring accidentally wanders away from them.

Computing device 260 can be a hardware/software entity permitting the collection and/or communication of telemetry 272. Computing device 260 can include, but is not limited to, a desktop computer, a laptop computer, a tablet computing device, a mobile phone, a park device (e.g., park device 106), and the like. Computing device 260 can be associated with sensor 262, user preference, interface 268, and the like. It should be appreciated that device 260 can be a user-owned device. For example, computing device can be a portable game system. In one instance, computing device 260 can be a third party provided device. In the instance, device 260 can be an electronic wristband, pager, electronic token, and the like. For example, a Radio Frequency Identification (RFID) token can register a visitor's location when the visitor is proximate to a RFID reader (e.g., entry point to an attraction). In one embodiment, the disclosure can leverage unique features of device 260 such as special lenses (e.g., fisheye, infrared etc). In the embodiment, features of device 260 can be automatically discovered and/or manually registered with system 200.

Sensor 262 can be one or more electronic components able to measure a physical parameter. Sensor 262 can include, but is not limited to, a camera, a microphone, a temperature sensor, a pressure sensor, an odor sensor, a proximity sensor, a location sensor (e.g., Global Positioning System receiver), a moisture sensor, an infrared sensor, and the like. Sensor 262 can be wire or wirelessly connected to computing device 260. Sensor 262 can collect telemetry passively and/or actively based on configuration settings and/or sensor capabilities. For example, audio telemetry can be collected while a user interacts with a mobile phone application.

Network 280 can be an electrical and/or computer network connecting one or more system 200 components. Network 280 can include, but is not limited to, twisted pair cabling, optical fiber, coaxial cable, and the like. Network 280 can include any combination of wired and/or wireless components. Network 280 topologies can include, but is not limited to, bus, star, mesh, and the like. Network 280 types can include, but is not limited to, Local Area Network (LAN), Wide Area Network (WAN), and the like.

In one instance, telemetry can be utilized to provide notifications 270 in response to visitor behavior. In the instance, pressure sensors within the device 260 can be measured and a determination can be performed to establish visitor emotional state. For example, when a visitor is grasping device 260 tightly, system 200 can assess that the visitor is rushing and provide necessary notifications to aid the visitor.

In one embodiment, audio telemetry can be analyzed and synchronized with the video telemetry. Audio and/or video recognition can extend to semantics and visitor identification (e.g., who is speaking). For example, if a visitor of a group (e.g., linked network) has spoken, the visitor's speech can be given greater weight than an unknown visitor. That is, system 200 can include software which can be trained to identify group members or can heuristically determine a visitor using past data. The system 200 can be configured to filter noise (e.g., background, proximate, etc) using various heuristic algorithms.

Drawings presented herein are for illustrative purposes only and should not be construed to limit the invention in any regard. It should be appreciated for security purposes that telemetry 272 can be sanitized permitting user identity protection. That is, personally identifiable information can be removed during telemetry collection, conveyance, and/or analysis. System 200 can utilize one or more traditional and/or proprietary technologies. Technologies can include, but is not limited to, Hypertext Markup Language (HTML), Extensible Markup Language (XML), Hypertext Transport Protocol (HTTP), HTTP Secure (HTTPS), Real-time Transport Protocol (RTP), User Datagram Protocol (UDP), Transport Control Protocol/Internet Protocol (TCP/IP), and the like.

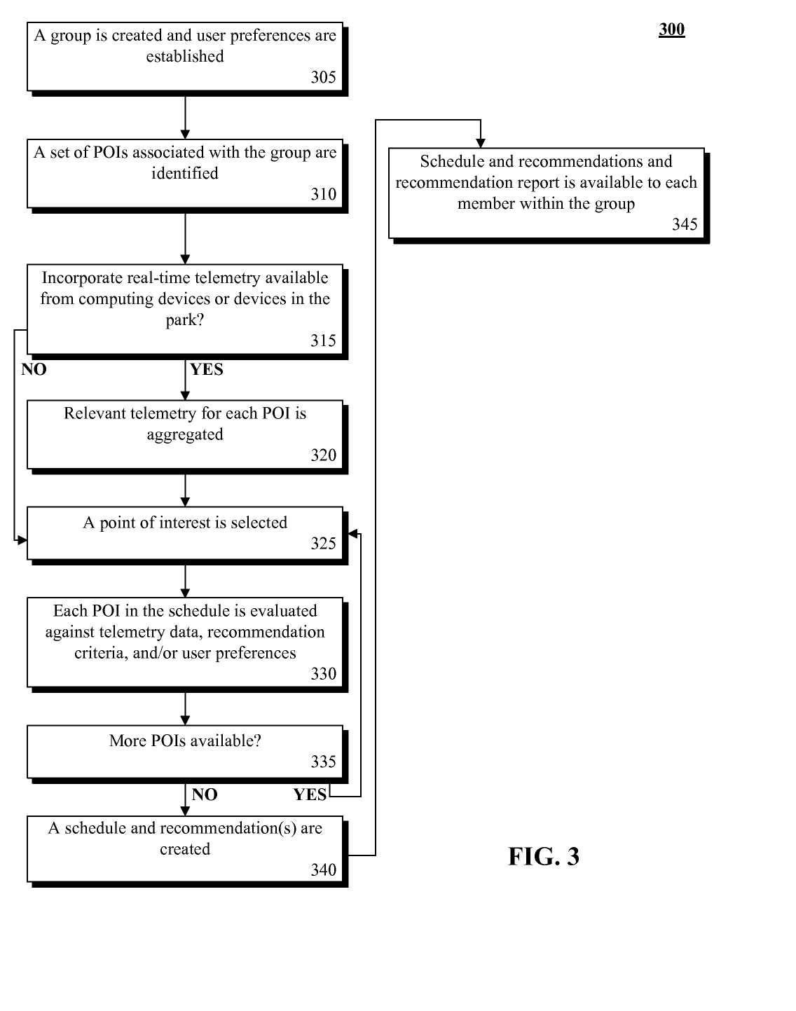

FIG. 3 is a schematic diagram illustrating a method 300 for providing dynamic recommendations for points of interest utilizing automatically obtained collective telemetry to enhance user experience in accordance with an embodiment of the inventive arrangements disclosed herein. Method 300 can be performed in the context of scenario 100, and/or system 200. In method 300, a group of visitors can be provided with recommendations associated with points of interest. Based on collected telemetry associated with points of interest, recommendations can be suggested. The recommendations can be evaluated against user and/or group preferences to provide relevant and helpful recommendations. A recommendation report can be created which can present an efficient schedule for one or more of the points of interest.

In step 305, a group can be created and user preferences can be established. The group can be automatically and/or manually created based on proximity, social relationships, and the like. In step 310, a set of points of interest associated with the group can be identified. The set of points of interest can be automatically and/or manually created. Points of interest selection can be performed in one or more traditional and/or proprietary mechanisms. For example, a visitor can select points of interest on a map within an interface. In step 315, a check can be made regarding whether telemetry data is available for these points of interest and regarding whether telemetry data is to be incorporated from a set of devices. The telemetry data can be real-time, near real-time, or delayed data depending on implementation specifics. The telemetry data can be obtained user devices and/or park devices. If telemetry data is to be incorporated, the method can progress to step 320, else to step 325. In step 320, relevant telemetry for each point of interest can be aggregated. In one instance, when telemetry is not available for a point of interest, historic data can be utilized to create an approximation of point of interest state.

In step 325, an initial schedule is created containing various points of interest. The schedule can be based on preferences, time of day, and the like. In step 330, the point of interest can be evaluated against telemetry data, recommendation criteria, and/or user preferences. In step 335, if more points of interest are available, the method can return to step 330. In step 340, a schedule and recommendations can be generated. The schedule and recommendations can include, but is not limited to, recommended activities, follow up activities, special events, promotions, and the like. In step 345, the schedule and recommendations are made available to each member in the group. In one instance, the group can conform to a publish/subscribe mechanism enabling, group members to selectively convey and receive notifications. In another embodiment, group members may have to log into a Web site or read email messages, or some other mechanism to receive the recommendations.

The flowchart and block diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be processed substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing real-time or near real-time schedules and recommendations comprising:
identifying a user preference associated with a plurality of points of interest, wherein the points of interest are associated with a geographical region;
receiving telemetry associated with a plurality of computing devices, wherein the plurality of computing devices is associated with at least one of the plurality of points of interest;
evaluating telemetry data against at least one recommendation criteria and the user preference; and
determining at least one schedule and recommendations based on the evaluating, wherein the schedule is an itinerary of at least one of the plurality of points of interest.

2. The method of claim 1, further comprising:
enabling a schedule and recommendation(s) to the plurality of computing devices.

3. The method of claim 2, further comprising:
presenting the schedule and recommendation(s) within a user interface associated with the plurality of computing devices.

4. The method of claim 1, wherein the telemetry data is automatically collected from a computing device during a pre-defined interval.

5. The method of claim 1, wherein the telemetry data is automatically collected in response to a polling event.

6. The method of claim 1, wherein the telemetry is at least one of a video stream, an audio stream, a temperature, a humidity metric, a pressure metric, an odor metric, a speed metric, and a metric.

7. The method of claim 1, wherein the recommendation criteria is one or more threshold values.

8. The method of claim 1, further comprising:
generating a schedule associated with one or more of the plurality of points of interest.

9. The method of claim 1, further comprising:
creating a linked network associated with a plurality of computing devices, wherein the plurality of computing devices are associated with the plurality of points of interest.

10. The method of claim 1, further comprising:
updating a schedule based on one or more recommendations.

11. A system for providing recommendations comprising:
a recommendation engine configured to generate at least one recommendation associated with telemetry received from a plurality of computing devices linked to a plurality of points of interest, wherein the at least one recommendation is at least one of the plurality of points of interest, wherein the at least one recommendation is generated utilizing at least one of a historic data, a recommendation criteria, and a preference, wherein the plurality of points of interest is associated with a geographical region; and
a data store able to store the at least one recommendation and the recommendation criteria, wherein the recommendation criteria is a threshold value evaluated against the telemetry to determine the state of at least one of the plurality of points of interest.

12. The system of claim 11, further comprising:
an analytics component able to examine the telemetry, historical data, criteria and preferences to determine a state associated with at least one of the plurality of points of interest;
a suggestion engine configured to determine the at least one recommendation associated with at least one of the plurality of points of interest; and
an optimization handler capable of improving the at least one recommendation.

13. The system of claim 11, wherein the telemetry is automatically collected via a computing device.

14. The system of claim 11, wherein the telemetry is automatically collected via a computing device embedded within a wristband.

15. The system of claim 11, wherein the telemetry is at least one of a video stream, an audio stream, a temperature, a humidity metric, a pressure metric, an odor metric, a speed metric, and a metric.

16. A computer program product comprising a computer readable storage medium having computer usable program code embodied therewith, the computer usable program code comprising:
computer usable program code stored in a storage medium, if said computer usable program code is run by a processor it is operable to identify a user preference associated with a plurality of points of interest, wherein the points of interest are associated with a geographical region;
computer usable program code stored in a storage medium, if said computer usable program code is run by a processor it is operable to receive telemetry associated with a plurality of computing devices, wherein the plurality of computing devices is associated with at least one of the plurality of points of interest;
computer usable program code stored in a storage medium, if said computer usable program code is run by a processor it is operable to evaluate telemetry data against at least one recommendation criteria and the user preference; and
computer usable program code stored in a storage medium, if said computer usable program code is run by a processor it is operable to determine at least one recommendation based on the evaluating, wherein the recommendation is at least one of the plurality of points of interest.

17. The computer program product of claim 16, wherein the telemetry data is automatically collected from a computing device during a pre-defined interval.

18. The computer program product of claim 16, wherein the telemetry data is automatically collected in response to a polling event.

19. The computer program product of claim 16, wherein the telemetry is at least one of a video stream, an audio stream, a temperature, a humidity metric, a pressure metric, an odor metric, a speed metric.

20. The computer program product of claim 16, wherein the telemetry is automatically collected via a computing device embedded within a wristband.

21. A system comprising hardware and software, wherein said software when run on the system causes the system to:
identify a user preferences associated with a plurality of points of interest, wherein the points of interest are associated with a geographical region;
receive telemetry associated with a plurality of computing devices, wherein the plurality of computing devices is associated with at least one of the plurality of points of interest;
evaluate telemetry data against at least one recommendation criteria and the user preference; and
determine at least one schedule and recommendations based on the evaluating, wherein the schedule is an itinerary of at least one of the plurality of points of interest.

22. The system of claim 21, wherein said software when run on the system causes the system to:
enable a schedule and recommendation(s) to the plurality of computing devices.

23. The system of claim 22, wherein said software when run on the system causes the system to:
present the schedule and recommendation(s) within a user interface associated with the plurality of computing devices.

24. The system of claim 21, wherein said software when run on the system causes the system to:
generate a schedule associated with one or more of the plurality of points of interest.

25. The system of claim 21, wherein said software when run on the system causes the system to:
create a linked network associated with a plurality of computing devices, wherein the plurality of computing devices are associated with the plurality of points of interest.
